(19) United States
(12) Patent Application Publication
(10) Pub. No.: US 2013/0344317 A1
(43) Pub. Date: Dec. 26, 2013

(54) SAFETY GLASS PANEL

(71) Applicants: Michel Rouby, Bray en Val (FR); Pierre Chaussade, Orleans (FR); Catherine Descusse, Chateauneuf Sur Loire (FR)

(72) Inventors: Michel Rouby, Bray en Val (FR); Pierre Chaussade, Orleans (FR); Catherine Descusse, Chateauneuf Sur Loire (FR)

(73) Assignee: SAINT-GOBAIN GLASS FRANCE, Courbevoie (FR)

(21) Appl. No.: 13/996,256

(22) PCT Filed: Dec. 20, 2011
(86) PCT No.: PCT/FR2011/053062

§ 371 Date: Sep. 16, 2013

(30) Foreign Application Priority Data
Dec. 20, 2010 (FR) 1060784

(51) Int. Cl. B32B 17/10

(52) U.S. Cl. CPC B32B 17/1077
USPC 428/334; 428/424.2; 428/339

(57) ABSTRACT

The invention relates to a glazing comprising a glass substrate and a complex sheet made of a plastic comprising a plasticized polyvinyl butyral layer and a polyester film provided with a scratch-resistant and abrasion-resistant coating, an adhesive layer of thermoplastic polyurethane being inserted between the glass substrate and the polyvinyl butyral layer of the complex sheet of plastic, characterized in that the adhesion of the polyester film to the polyvinyl butyral layer, measured by exerting on a 1 cm wide strip of the polyester film a tensile force perpendicular to the surface of the glazing with a pull rate of 5 cm/min, is at least equal to 3 daN/cm.

It also relates to the application of such a glazing for an airborne transport vehicle in particular.

The present invention relates to safety glazing for which penetration resistance, absorption of energy (such as produced by an impact) and anti-lacerative and anti-scratch properties are desired so as to guarantee a lasting preservation of a high optical quality of transparency. In particular, this glazing may be used for a transport vehicle, in particular an airborne transport vehicle that may be subjected to unexpected impacts such as bird strikes.

Such glazing is known from patent EP 707 951 B1 comprising a glass substrate and a complex sheet made of plastic comprising a plasticized polyvinyl butyral layer and a polyester film provided with a scratch-resistant and abrasion-resistant coating, in which an adhesive layer of thermoplastic polyurethane is inserted between the glass substrate and the polyvinyl butyral layer of the complex sheet of plastic.

The inventors have now become aware that the desired functionalities of the glazing defined above are capable of being improved for an increased adhesion of the polyester film to the polyvinyl butyral layer.

For this purpose, one subject of the invention is a glazing comprising a glass substrate and a complex sheet made of a plastic comprising a plasticized polyvinyl butyral layer and a polyester film provided with a scratch-resistant and abrasion-resistant coating, an adhesive layer of thermoplastic polyurethane being inserted between the glass substrate and the polyvinyl butyral layer of the complex sheet of plastic, characterized in that the adhesion of the polyester film to the polyvinyl butyral layer, measured by exerting on a 1 cm wide strip of the polyester film a tensile force perpendicular to the surface of the glazing with a pull rate of 5 cm/min, is at least equal to 3 daN/cm (preferably 4 daN/cm and particularly preferably 5 daN/cm).

This value, higher than in the glazings of this type that are currently known, provides a better lasting resistance to the impacts undergone under the targeted usage conditions, in particular to bird strikes. It must be measured under all the usage conditions of the glazing, in particular temperature, moisture and salinity conditions, including throughout its service life.

The adhesive polyurethane layer makes it possible to retain a good adhesion of the complex sheet by means of its PVB layer with the glass substrate, under very variable temperature and moisture conditions.

The combination thus produced in a “bilayer” glazing of an adhesive and energy-absorbing layer made of polyurethane and of an energy-absorbing layer made of PVB makes it possible to retain the good anti-penetration and/or anti-splinter properties of the glazing over a very wide range of temperatures and especially at low temperatures, that is to say at temperatures below 0° C. and even below −20° C.

The scratch-resistant and abrasion-resistant coating may be a hard coating based on polysiloxane or similar.

In accordance with the invention, the adhesion of the polyester film to the polyvinyl butyral layer is measured at a pull rate of 5 cm/min; it is however specified that this rate is between 2 and 5 cm/min, possibly being equal to 2 cm/min with the measured adhesion value barely changing at all.

The inventors have furthermore determined that the adhesion of the polyester film to the polyvinyl butyral layer is preferably at most equal to 8 daN/cm, preferably 7 daN/cm so as to allow a gradual detachment of the polyester film from the polyvinyl butyral layer during a bird strike or similar. In the case of greater adhesion, a bird strike causes the rupture of the polyester (PET) film: the complex sheet of plastic then behaves like a monolithic block, and begins to lose its anti-splinter property.

The glass substrate may be a laminated substrate or a monolithic substrate. The glass sheet or sheets may be made of annealed glass, or of thermal tempered or chemical tempered glass.

Various glass compositions are preferably used:
a soda-lime-silica glass,
a glass essentially free of CaO, as described in patent application WO 98/46537,
a glass having, in the form of a 3.2 mm thick, respectively 4 mm thick, sheet, a light transmission

T_{L} and/or an energy transmission T_{E} of at least 90%; this is particularly advantageous for night vision with amplifying infrared telescopic sights.

In order to quantify the transmission of the glass in the visible range, a light transmission factor is thus defined, referred to as light transmission, often abbreviated to “T_{L}”, calculated between 380 and 780 nm and normalized to a glass thickness of 3.2 mm or 4 mm, according to the standard ISO 9050: 2003, by therefore taking into consideration the illuminant D65 as defined by the standard ISO/CIE 10526 and the CIE 1931 reference colorimetric observer as defined by the standard ISO/CIE 10527. In order to quantify the transmission of the glass in the range encompassing the visible and the solar infrared (also referred to as “near infrared”), an energy transmission factor is defined, referred to as “energy transmission”, abbreviated to “T_{E}”, calculated according to the standard ISO 9050 and normalized to a glass thickness of 3.2 mm or 4 mm. According to the standard ISO 9050, the range of wavelengths used for the calculation ranges from 300 to 2500 nm.

It is known, in order to reach values of T_{L} and T_{E} of greater than 90%, to reduce as much as possible the total content of iron oxide in the glass. Iron oxide, present as an impurity in most natural raw materials used in glass making (sand, feldspar, limestone, dolomite, etc.), absorbs both in the visible and near ultraviolet range (absorption due to the ferric ion Fe³⁺) and above all in the visible and near infrared range (absorption due to the ferrous ion Fe²⁺). With standard natural raw materials, the total weight content of iron oxide is of the order of 0.1% (1000 ppm). Transmissions of more than 90% however require lowering the iron oxide content to less than 0.02% or 200 ppm, or even less than 0.01% (100 ppm), which makes it necessary to choose particularly pure raw materials and increases the cost of the final product.

In order to increase the transmission of the glass even more, it is also known to reduce the content of ferrous iron in favor of the content of ferric iron, therefore to oxidize the iron present in the glass. Thus, glasses having the lowest possible “redox”, ideally 0 or virtually 0, are targeted, the redox being defined as being the ratio between the weight content of FeO (ferrous iron) to the weight content of total iron oxide (expressed in the form Fe₂O₃) . This number may vary between 0 and 0.9, zero redox values corresponding to a completely oxidized glass.

Glasses comprising standard contents of iron oxide, of the order of 1000 ppm or more, naturally have redox values of the order of 0.25. On the other hand, glasses comprising small amounts of iron oxide, in particular less than 200 ppm, or even less than 150 ppm, have a natural tendency to exhibit high redox values, of greater than 0.4, or even of greater than 0.5. This tendency is probably due to a shift of the redox equilibrium of the iron as a function of the iron oxide content.

Thus, one of the glass compositions preferred for the implementation of the invention has an iron oxide content of at most 150 ppm, or better still 100 ppm and a redox value at most equal to 0.3, preferably 0.2.

In order to allow night vision with amplifying infrared telescopic sights under the best conditions, the glazing of the invention, with an indicative glass thickness of 3 mm, respectively 4 mm, equipped with a heating layer of ITO (tin-doped indium oxide) type, thermoplastic polyurethane and the complex sheet made of Spallshield® plastic, thus advantageously has values of T_{L} and/or T_{E} at least equal to 75%, preferably 80%, or even 85%.

However, the use of glass that is less clear, in particular that is bulk-tinted, or of glass coated with a solar-protection layer such as a silver layer, also falls within the scope of the invention.

Indeed, in the case of an application in which night vision is not so important, it is also advantageous to benefit from the glass substrate for the solar-protection function: either by using bulk-tinted glass, of motor vehicle functional tint type, which makes it possible to lower the light and energy transmission, or by using silver-based solar-protection layers. In certain cases, the glazing is required to be heated glazing, in order to provide deicing and demisting in all circumstances. The glass is then equipped with a layer of ITO, tin-doped indium oxide (INDIEX®, registered trademark of Saint-Gobain Glass France), between two current leads made of silver enamel. If the glass must be both solar-protection and heated glass, the glass may advantageously be coated with a silver-based, but also heating, layer. Finally, if it is not possible to use a layered glass, it is also possible to insert into the plastic part of the bilayer, between the TPU and PVB thermoplastic films, a solar-protection film of PVB/PET type with a silver/PVB layer.

The polyurethane layer is advantageously in the form of a film of aliphatic, or cycloaliphatic, or aliphatic-aromatic thermoplastic polyurethane. Its thickness is at least equal to 0.1 mm, preferably 0.2 mm, sufficient to provide the required energy-absorbing properties, and at most equal to 6 mm, preferably 4.5 mm, values above which no additional advantage is obtained. In particular, this thickness is a multiple of 0.38 mm.

The polyurethane layer is generally formed from an isocyanate component chosen from aliphatic, cyclo-aliphatic or aliphatic-aromatic isocyanates that are not sensitive to light, and which may contain urea functions, or else isocyanate biurets, and from a polyol component comprising at least one long polyol chosen from polyether polyols or polyester polyols having a molecular weight between 450 and 2000, poly-caprolactones having a molecular weight between 500 and 2000, polycarbonate polyols and polyester polycarbonate polyols having a molecular weight between 1000 and 2000, polybutadienes with a hydroxyl or carboxyl function, associated where appropriate with at least one short diol having a molecular weight of between 50 and 200.

Use may in particular be made, as isocyanate, of aliphatic difunctional isocyanates such as 1,6-hexanediisocyanate, 2,2,4-trimethyl-1,6-hexanediisocyanate, 2,4,4-trimethyl-1,6-hexanediisocyanate, 1,3-bis(isocyanatomethyl)benzene, bis(4-isocyanatocyclohexyl)methane, bis(3-methyl-4-isocyanatocyclohexyl)methane, 2,2-bis(4-isocyanatocyclohexyl)propane, 3-isocyanatomethyl-3,5,5-trimethylcyclohexylisocyanate, p-phenylenediisocyanate and p-cyclohexyldiisocyanate.

Use is for example made, as polyols, of the polyols obtained by the reaction of polyfunctional alcohols with aliphatic diacids or cyclic ethers. The polyfunctional alcohols are, for example, 1,2-ethanediol (ethylene glycol), 1,2-propanediol, 1,3-propanediol, 1,2-butanediol, 1,4-butanediol, 2,2-dimethyl-1,3-propanediol (neopentyl glycol), 1,6-hexanediol, 2-methyl-2,4-pentanediol, 3-methyl-2,4-pentanediol, 2-ethyl-1,3-hexanediol, 2,2,4-trimethyl-1,3-pentanediol, diethylene glycol, triethylene glycol, polyethylene glycols, dipropylene glycol, tripropylene glycol, polypropylene glycols, 2,2-bis(hydroxymethyl)-1-propanol (trimethylolethane), 2,2-bis(hydroxymethyl)-1-butanol (trimethylolpropane), 1,2,4-butanetriol, 1,2,6-hexanetriol, 2,2-bis(hydroxymethyl)-1,3-propanediol (pentaerythritol), 1,2,3,4,5,6-hexane-hexol (sorbitol), cyclohexanedimethanol.

The aliphatic diacids are, for example, malonic acid, succinic acid, glutaric acid, adipic acid, suberic acid and sebacic acid.

The polyol component may also comprise, where appropriate, a crosslinking agent having a functionality of greater than 2, such as a triol having a molecular weight of between 100 and 3000.

The complex sheet is formed from a plasticized PVB layer combined with a film of polyester such as polyethylene terephthalate (PET) coated with a hard anti-scratch and anti-abrasion protective layer based on polysiloxane or with a self-healing layer based on a polyurethane, preferably a crosslinked (thermosetting) polyurethane.

A suitable plasticized PVB is for example sold under the name SAFLEX® by the company SOLUTIA or else sold under the name BUTACITE® by the company DU PONT DE NEMOURS. Its thickness is, for example, 0.38 mm or 0.76 mm.

The polyester film has a thickness generally of less than 0.5 mm. The hard organopolysiloxane coating is generally between 0.5 and 50 μm.

The complex sheet formed from a layer of PVB and from a film of polyester, in particular PET, coated with an anti-scratch and anti-abrasion layer may be manufactured at the same time as the operation for assembling the glazing, by stacking of the elements. Advantageously, the invention uses a prefabricated complex sheet comprising a layer of PVB having a thickness of 0.38 or 0.76 mm and a polyethylene terephthalate film having a thickness of around 0.2 mm coated with a polysiloxane layer. Such a complex sheet is sold, for example, under the name SPALLSHIELD® by the company DU PONT DE NEMOURS.

Another subject of the invention is the application of the glazing described above for an airborne, water-borne or terrestrial transport vehicle, for buildings, furniture, interior fittings, electrical goods or street furniture and in particular as helicopter glazing.

Other advantages and features of the invention will appear in the description of the following example.

### EXAMPLE

Three complex sheets of plastic, respectively sold by the company DU PONT DE NEMOURS under the registered trademarks SPALLSHIELD® BE 1028-157, SPALLSHIELD® SG2-157 and SPALLSHIELD® SG2-307 are used. For convenience, they will be denoted hereinbelow as 1028, SG2-157 and SG2-307.

1028 and SG2-157 consist of a 0.38 mm sheet of plasticized PVB and of a 0.18 mm sheet of polyethylene terephthalate (PET) varnished with a layer of polysiloxane.

SG2-307 differs therefrom due to the 0.76 mm thickness of the sheet of plasticized PVB.

SG2-157 and SG2-307 are completely identical in the nature of their constituents. On the other hand, 1028 has a PVB that is different in the nature and the content of the plasticizer that it contains, and its varnished PET sheet has not been subjected, on its face intended to adhere to the plasticized PVB, to the same adhesive bonding treatment as that of the two other complex sheets, so that the adhesion of its PET film to its sheet of plasticized PVB never exceeds 2 daN/cm irrespective of the measurement conditions. This value is measured, here and subsequently, in accordance with the invention, by the peel test method which consists in exerting, on a 1 cm wide strip of the PET film, a tensile force perpendicular to the surface of the glazing (and of the plasticized PVB sheet) with a pull rate of 2 cm/min. 1028, consequently representing the prior art as set out in patent EP 707 951 B1, is not therefore in accordance with the invention.

On the other hand, SG2-157 and SG2-307 are in accordance with the invention and have the following identical values of PET/PVB adhesion:
7.9 ±0.5 daN/cm at 20° C.;
5.8 ±1.5 daN/cm (tearing of the PVB on certain test specimens) after 14 days of moist heat: 50° C. and 95% relative humidity;
6.5±0.5 daN/cm (tearing of the PVB on one test specimen) after 500 h of aging with ultraviolet radiation of type A, wavelength of 295 to 400 nm, at a temperature of 50° C. (QUV A).

A sheet of chemically tempered soda-lime-silica float glass having a thickness of 3 mm is combined with each of the three complex sheets of plastic described previously,
by means of a sheet of thermoplastic polyurethane having a thickness of 1.14 mm for 1028 and SG2-157, and having a thickness of 0.76 mm for SG2-307, in a first series,
by means of a sheet of thermoplastic polyurethane having a thickness of 4.18 mm for 1028 and SG2-157, and having a thickness of 3.8 mm for SG2-307, in a second series.

In each of said first and second series, SG2-157 and SG2-307 withstand bird strike type impacts better than 1028, including in the guaranteed minimum service life, and the aging conditions of a helicopter glazing, in particular.

1. A glazing comprising:
a glass substrate and a complex sheet comprising a plastic comprising a plasticized polyvinyl butyral layer and a polyester film with comprising a scratch-resistant and abrasion-resistant coating, an adhesive layer of thermoplastic polyurethane being inserted between the glass substrate and the polyvinyl butyral layer of the complex sheet of plastic, wherein the adhesion of the polyester film to the polyvinyl butyral layer, measured by exerting on a 1 cm wide strip of the polyester film a tensile force perpendicular to the surface of the glazing with a pull rate of 5 cm/min, is at least equal to 3 daN/cm.

2. The glazing of claim 1, wherein the adhesion of the polyester film to the polyvinyl butyral layer is at least equal to 4 daN/cm.

3. The glazing of claim 1, wherein the adhesion of the polyester film to the polyvinyl butyral layer is at least equal to 5 daN/cm.

4. The glazing of claim 1, wherein the adhesion of the polyester film to the polyvinyl butyral layer is at most equal to 8 daN/cm.

5. The glazing of claim 1, wherein the adhesion of the polyester film to the polyvinyl butyral layer is at most equal to 7 daN/cm.

6. The glazing of claim 1, wherein the glass substrate is a sheet of annealed or tempered glass.

7. The glazing of claim 6, wherein the glass is chemically tempered.

8. The glazing of claim 6, wherein the glass is a soda-lime-silica glass or a glass that is essentially free of CaO.

9. The glazing of claim 6, wherein the glass has, in the form of a 3.2 mm thick, respectively 4 mm thick sheet, a light transmission T_{L} of at least 90%.

10. The glazing of claim 6, wherein the glass has, in the form of a 3.2 mm thick, respectively 4 mm thick sheet, an energy transmission T_{E} of at least 90%.

11. The glazing of claim 1, wherein the layer of thermoplastic polyurethane has a thickness at least equal to 0.1 mm.

12. The glazing of claim 1, wherein the layer of thermoplastic polyurethane has a thickness at most equal to 6 mm.

13. A vehicle comprising the glazing of claim 1, wherein the vehicle is an airborne, water-borne or terrestrial transport vehicle.

14. A helicopter glazing comprising the glazing of claim 1.

15. The glazing of claim 1, wherein the layer of thermo-plastic polyurethane has a thickness at least equal to 0.2 mm.

16. The glazing of claim 1, wherein the layer of thermo-plastic polyurethane has a thickness at most equal to 4.5 mm.

17. A building comprising the glazing of claim 1.

18. Furniture comprising the glazing of claim 1.

19. An interior fitting comprising the glazing of claim 1.

20. An electrical good comprising the glazing of claim 1.
